(19) United States
(12) Patent Application Publication
(10) Pub. No.: US 2012/0203644 A1
(43) Pub. Date: Aug. 9, 2012

(54) APPARATUS, SYSTEM AND METHOD FOR PROVIDING ELECTRONIC RECEIPTS

(75) Inventor: Gareth Phillips, Midlothian (GB)

(73) Assignee: THE ROYAL BANK OF SCOTLAND PLC, Edinburgh (GB)

(21) Appl. No.: 13/419,823

(22) Filed: Mar. 14, 2012

Related U.S. Application Data
(63) Continuation of application No. PCT/EP2010/063494, filed on Sep. 14, 2010.

(30) Foreign Application Priority Data
Sep. 14, 2009 (GB) 0916041.7

(51) Int. Cl. G06Q 30/00; G06Q 20/20

(52) U.S. Cl. 705/17; 705/26.1

(57) ABSTRACT

An electronic receipt server comprises an interface, a data store, and a processor adapted, on receiving receipt data associated with a customer purchase transaction from a first entity, to generate a reference associated with the customer purchase transaction, store the receipt data in the data store in association with the reference and return the reference to the first entity, and on receipt of a request comprising the reference from a second entity, to send an electronic receipt to the second entity, the electronic receipt being associated with the reference and presenting the customer purchase transaction according to the receipt data.

### RELATED APPLICATIONS

This application is continuation of International Application No. PCT/EP2010/063494 filed Sep. 14, 2010, which claims the benefit of Great Britain Application No. 0916041.7 filed on Sep. 14, 2009, the contents of which are herein incorporated by reference.

### TECHNICAL FIELD

The present disclosure relates to apparatus, systems and methods for providing an electronic receipt for a transaction. More particularly, but not exclusively, the present disclosure relates to receipts generated for transactions made using a credit, debit, or other payment card.

### BACKGROUND

When a customer initiates an electronic transaction to purchase goods or services, information is exchanged between a plurality of entities. Typically, the entities may include the customer who initiates a transaction using a credit card, debit card, or other payment card (herein collectively termed a payment card), a merchant with whom the transaction is initiated, an acquiring bank that accepts payment on behalf of the merchant, an issuing bank which assumes liability for the customer and a card association which performs transaction processing on behalf of the acquiring and issuing banks (for example MasterCard™ and Visa™). The exchange of electronic information between the entities is generally implemented using one or more transaction networks which are operated by one or more further independent entities (for example CardNet™ and VisaNet™)

A customer can initiate a transaction with a merchant either in person (herein termed an in person transaction), or remotely via a telephone, facsimile or via the Internet (herein termed a remote transaction). The transaction is initiated at a point of sale such as an electronic point of sale (EPoS) system in a retail store, or an e-commerce website provided by the merchant. In all cases, the customer is required to provide his or her payment card details and sufficient supplementary information in order to authenticate the customer. The supplementary information may include a PIN number, the customer's address or payment card expiry date.

Typically, a transaction will comprises a number of steps including, but not limited to: (i) validation of the customer's payment card details (ii) authorisation of the transaction with the issuing bank, (iii) batching of the authorised transactions with the acquiring bank, (iv) clearing and settlement between the acquiring and issuing banks made via the card association, and (v) payment of funds from the acquiring bank to the merchant.

According to prior art methods, upon completion of a transaction, the customer is generally provided with a printed receipt (in the case of an in person transaction), or a web page or e-mail detailing the transaction details which can be printed by the customer (in the case of an e-commerce transaction). The receipt is an acknowledgement that a specified article or sum of money has been received as an exchange for goods or services, and acts as the title to the property obtained in the exchange. In some prior art methods, the merchant will send a receipt to the customer in the form of an e-mail which the customer can print and keep for his or her records, or even send a receipt by post.

Prior art methods typically require printing, storing and organization of a large number of receipts, which is a considerable inconvenience for the customer. Moreover, the prior art systems do not provide means for linking a transaction appearing on a customer's bank statement, and the receipt retained by the customer. It is therefore desirable to provide a system which facilitates electronic storage of receipts and also provides a means for linking a transaction appearing on the customer's bank statement and the electronic record of the receipt. However, as described above, current card payment systems involve several independent entities and it is therefore also desirable to provide a solution which is compatible with the standards employed by established payment systems in order that the solution can be implemented with minimum disruption, system development and redeployment.

### SUMMARY

In accordance with an exemplary aspect of the present disclosure, there is provided an electronic receipt server comprising: an interface; a data store; and, a processor adapted: on receiving receipt data associated with a customer purchase transaction from a first entity, to generate a reference associated with the customer purchase transaction, store the receipt data in the data store in association with the reference and return the reference to the first entity; on receipt of a request comprising the reference from a second entity, to send an electronic receipt to the second entity, the electronic receipt being associated with the reference and presenting the customer purchase transaction according to the receipt data.

In accordance with another exemplary aspect of the present disclosure, there is provided an electronic point of sale system comprising: a card reader adapted to read card details from a payment card; and, a terminal adapted to: send receipt data associated with a customer purchase transaction to a first entity; receive a reference associated with an electronic receipt corresponding to the customer purchase transaction from the first entity; embed the reference in a message associated with the customer purchase transaction; and, send the message to a second entity.

In accordance with another exemplary aspect of the present disclosure, there is provided a method of generating an electronic receipt comprising: receiving receipt data associated with a customer purchase transaction from a first entity; generating a reference associated with the customer purchase transaction; storing the receipt data in the data store in association with the reference; and, returning the reference to the first entity.

In accordance with another exemplary aspect of the present disclosure, there is provided a method of processing a customer purchase transaction comprising: reading card details from a payment card; sending receipt data associated with a customer purchase transaction to a first entity; receiving a reference associated with an electronic receipt corresponding to the customer purchase transaction from the first entity; embedding the reference in a message associated with the customer purchase transaction; and, sending the message to a second entity.

In accordance with another exemplary aspect of the present disclosure, there is provided an e-commerce point of sale server adapted to: receive card details from a payment card; send receipt data associated with a customer purchase transaction to a first entity; receive a reference associated with an electronic receipt corresponding to the customer purchase transaction from the first entity; embed the reference in a message associated with the customer purchase transaction; and, send the message to a second entity.

In accordance with another exemplary aspect of the present disclosure, there is provided a payment card comprising a processor chip storing the address of an electronic receipt server in accordance with the first aspect of the present invention.

In accordance with another exemplary aspect of the present disclosure, there is provided an e-commerce point of sale server adapted to: receive card details from a payment card; send receipt data associated with a customer purchase transaction to a first entity; receive a reference associated with an electronic receipt corresponding to the customer purchase transaction from the first entity; embed the reference in a message associated with the customer purchase transaction; and, send the message to a second entity.

### BRIEF DESCRIPTION OF THE DRAWINGS

FIG. 1 is a block diagram which shows a payment system in accordance with an exemplary embodiment of the present disclosure.

FIG. 2 is a block diagram which shows the flow of information associated with a transaction in accordance with an exemplary embodiment of the present disclosure.

FIG. 3A is a block diagram which shows the flow of information associated with viewing an electronic receipt in accordance with an exemplary embodiment of the present disclosure.

FIG. 3B is a block diagram which shows the flow of information associated with viewing an electronic receipt in accordance with an exemplary embodiment of the present disclosure.

FIG. 4A is a diagram which illustrates an exemplary payment card statement in accordance with an exemplary embodiment of the present disclosure.

FIG. 4A is a diagram which illustrates an exemplary e-receipt in accordance with an exemplary embodiment of the present disclosure.

FIG. 5A is a block diagram which shows the components of an exemplary e-receipt server in accordance with an exemplary embodiment of the present disclosure.

FIG. 5B is a block diagram which shows the functional operation of an exemplary e-receipt server in accordance with an exemplary embodiment of the present disclosure.

FIG. 6 is a flow diagram showing a method for generating an exemplary e-receipt in accordance with an exemplary embodiment of the present disclosure.

FIG. 7 is a diagram which illustrates an exemplary electronic point of sale system in accordance with an exemplary embodiment of the present disclosure.

FIG. 8 is a block diagram which shows the functional operation of an exemplary electronic point of sale system in accordance with an exemplary embodiment of the present disclosure.

FIG. 9 is a flow chart showing an exemplary method for performing a transaction in accordance with an exemplary embodiment of the present disclosure.

FIG. 10 is a block diagram which shows the flow of information associated with an exemplary transaction in accordance with an exemplary embodiment of the present disclosure incorporating non-repudiation methods.

FIG. 11 is a block diagram which shows the flow of information associated with an exemplary transaction in accordance with an exemplary embodiment of the present disclosure wherein an e-receipt is generated prior to authorisation of a transaction.

FIG. 12 is a flow chart showing an exemplary method for performing a transaction in accordance with an exemplary embodiment of the present disclosure wherein an e-receipt is generated prior to authorisation of a transaction.

FIG. 13 is a block diagram which shows an exemplary e-commerce point of sale server in accordance with an exemplary embodiment of the present disclosure.

FIG. 14 is a block diagram which shows the functional operation of an exemplary e-commerce point of sale server in accordance with an exemplary embodiment of the present disclosure.

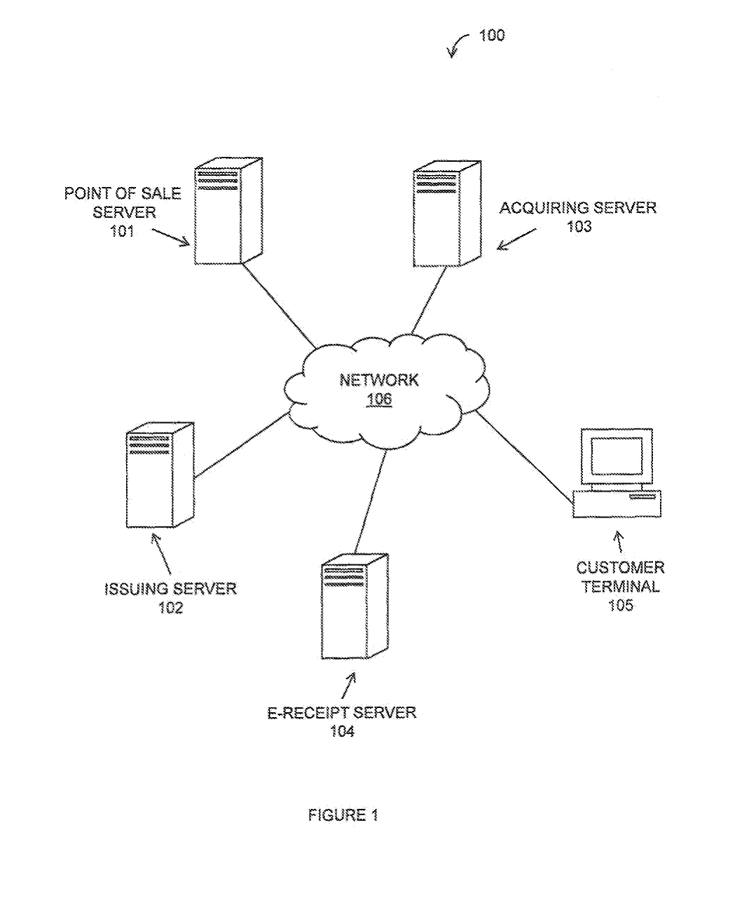

FIG. 1 shows a system 100 for generating, storing and retrieving electronic receipts in accordance with an exemplary embodiment of the present disclosure. For convenience, the system will be described in terms of a server associated with each of the entities. However, it will be appreciated that a server may correspond to a single device, or a plurality of networked devices operating in combination under a single network domain. Therefore, functionality described in association with a particular server in the following description may in reality be achieved using more than one device. Such alternative arrangements are well established within the art.

The system 100 comprises a point of sale server 101 associated with the merchant, an issuing server 102 associated with the issuing bank, an acquiring server 103 associated with the acquiring bank, and an e-receipt server 104. Also included in the system is a customer terminal 105 whereby a customer may initiate an electronic transaction with the point of sale 101. Typically, the customer terminal will be equipped with an Internet browser and network connection, and suitable devices include, but are not limited to, personal computers, personal digital assistants (PDA), and mobile or cellular phones. Each entity in the system is able to send and receive data to or from the other entities in the system via a network 106.

In some embodiments of the disclosure, the point of sale may be an e-commerce system whereby the customer can effect transactions with the merchant via a website provided by the point of sale server 101. Typically, the customer will navigate to the website provided by the merchant, select the products or services which he or she wishes to purchase and then provide payment for the goods or services using his or her payment card details which are sent securely via the network 106. Alternatively, the point of sale server 101 may be an EPoS system in a merchant's premises whereby the customer is able to initiate a transaction in person using their payment card. In some embodiments, EPoS system may communicate directly with the issuing server 102 by sending data over a standard telephone line using a modem.

Typically, data exchange between the entities shown in FIG. 1 may be performed using encryption and authentication techniques to ensure the confidentiality and integrity of the data, although is not required. For example, the data may be encrypted using Secure Sockets Layer (SSL), RSA algorithms or similar. Furthermore, data may be signed using an algorithm such as the Secure Hash Algorithm (SHA) or similar. Such techniques are well established in the art.

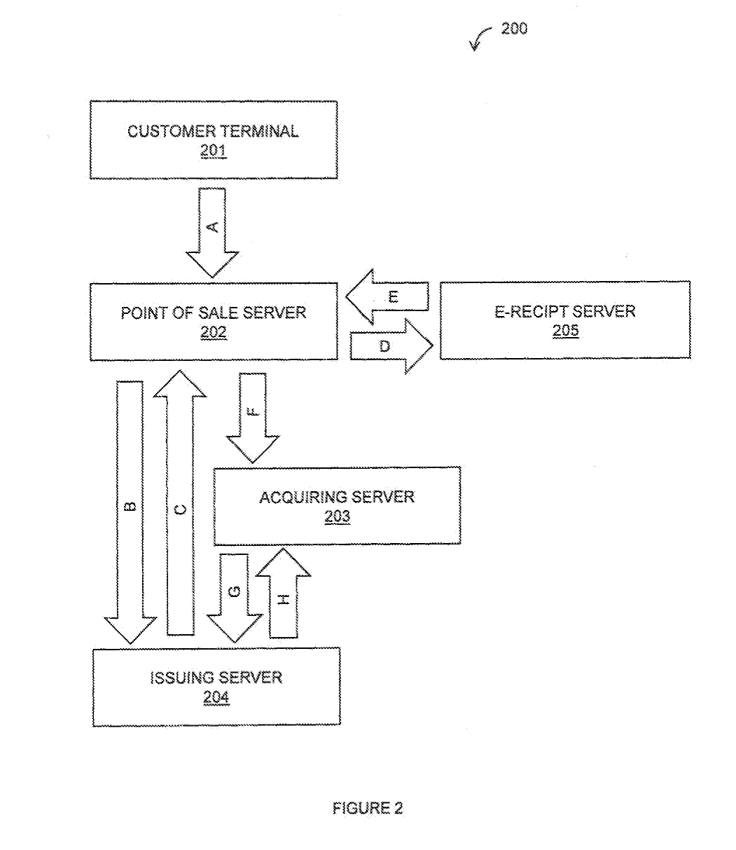

FIG. 2 shows the flow of information 200 resulting from an electronic transaction initiated by a customer in accordance with an exemplary embodiment of the present disclosure. First the customer initiates an electronic transaction with a merchant at the point of sale server 202, either by purchasing goods and services via an e-commerce website, or in person using an EPoS system (for example in a retail store). In both instances, the customer provides payment card details such as payment card number and expiry date (and optionally relevant cardholder data such as name or date of birth) which are sent to the point of sale server 202, along with details of the goods and/or services purchased, in message A. Goods involved in the transaction may be identified by an identification code such as the Stock Keeping Unit (SKU) number, which is a widely used identifier used by merchants in the United Kingdom, or any other desired identifier.

Next, the point of sale server 202 generates and transmits a message B containing details of the transaction to the issuing server of the customer 204 using a suitable protocol (for example the ISO 8583 standard for financial transaction card originating messages, hereby incorporated by reference). Although not shown in FIG. 2, message B is generally sent to the issuing server 204 via the acquiring server of the merchant 203. The transaction message will typically comprise information derived from the payment card used (for example the account number, expiry date), the point of sale used to make the transaction (for example the merchant number), the transaction amount and currency. It will be appreciated that intervening systems and devices not shown in FIGS. 1 or 2 may further augment the data with additional information including but not limited to date stamps, digital signatures and other data for security and authentication purposes.

Upon receipt of the message B from the point of sale server 202, the issuing server 204 of the customer may perform one or more checks to confirm the transaction is genuine (i.e. not fraudulent) and that the customer has sufficient funds or credit in place to purchase the goods or services. If the message is genuine and the customer has sufficient funds or credit to complete the transaction, the issuing server 204 returns a message C approving the transaction. Again, message C may in some embodiments be returned to the point of sale server 202 via the acquiring server of the merchant 203 (not shown in FIG. 2).

Upon receipt of message C, the point of sale server 202 sends a message D to the e-receipt server 205 containing the details of the goods and/or services and the details of the payment card used by the customer. The e-receipt server 205 generates a unique alphanumeric reference for the transaction based on some or all of the payment card details (and optionally relevant cardholder data such as name or date of birth) and stores the details of goods/services with the reference. Next, a transaction identifier which includes the reference is returned to the point of sale server 202 in message E.

In some embodiments, before sending details of the goods and services to the e-receipt server 205, the point of sale server may optionally present the customer with an option to generate an e-receipt. For example, in the case of an EPoS system, the customer may be prompted to press “OK” on a card reader keypad if they want an e-receipt, or “CANCEL” if they do not require a receipt. Thus, the customer has the option to prevent a receipt from being generated for goods and services of a trivial or private nature. In a further embodiment, if the customer does not require or want an e-receipt to be generated (i.e. the customer presses “CANCEL” on the keypad), a conventional paper receipt may be printed by a conventional receipt printer operably attached to the EPoS system. In yet another embodiment, the contents of the e-receipt may be presented to the customer on a screen for validation prior to sending to the e-receipt server 205.

Typically, the reference may be generated by the e-receipt server 205 based on a hash of the payment card number such that the transaction is linked with the customer without requiring the e-receipt server to store the customer payment card details. Alternatively or additionally, the reference may be generated based on a hash of the payment card number with a timestamp such that the reference is unique to the transaction in question. It will be appreciated that the reference can be generated using a wide range of techniques, all of which are encompassed within the scope of the present disclosure.

In an alternative exemplary embodiment, the reference may simply take the form of a time stamp indicating the time at which the transaction took place or the receipt was generated. Since a payment card can only be used to make one transaction at any particular time, the time stamp (in combination with the payment card number included in the transaction details of message F) provides a unique reference for the transaction without collisions. The time stamp data may be provided by the point of sale server 202 and correspond to the transaction timestamp, thereby ensuring an exact correspondence between a transaction and the associated e-receipt. In an alternative embodiment, the timestamp may be provided by the e-receipt server. In yet a further embodiment, the timestamp may be provided by the standard clock of the card association in question (e.g. VISA™ or MasterCard™)

Next, the point of sale server 202 proceeds to send a message F to the acquiring server containing the transaction details including a narrative provided by the merchant. Typically the narrative will include text containing the merchant name and short address and will appear on the customer's paper or electronic bank statement with the corresponding transaction. In embodiments of the present disclosure, the identifier generated by the e-receipt server 205 and associated with the transaction is embedded in the narrative field in message F (it will be appreciated by a skilled person that the term ‘embed’ or conjugations thereof is non-limiting, and is intended, for example, to include ‘appending’ and/or ‘including’ or conjugations thereof). Thus the narrative associated with the transaction provides a link to the record of the associated goods and services stored on the e-receipt server.

Settlement of the transaction between the acquiring bank and the issuing bank (i.e. the transfer of funds) may be performed in real time, in batches or according to a daily schedule. Although settlement may be achieved via direct communication between the acquiring server 203 and the issuing server 204 (messages G and H), it is more common to use a bank card association such as MasterCard™ or Visa™. Following settlement, the acquiring server 203 and issuing server 204 update the merchant and customer accounts respectively in accordance with the transaction.

In some embodiments of the disclosure, the identifier generated by the e-receipt server 205 and embedded in the transaction narrative takes the form of a universal resource locator (URL) which points to the e-receipt provider domain and includes the alphanumeric reference associated with the transaction. For example, if the e-receipt server generates a reference 2b01a2M associated with a particular transaction, the identifier may take the URL: www.domain.com/2b01a2f0 where www.domain.com is the network domain of the e-receipt server, and in some embodiments this could correspond to the domain of the issuing or acquiring bank. It should be noted that the above reference has been shortened for clarity purposes and in practice the length and format of the identifier must be such as to avoid collisions where two different transactions lead to identical reference numbers. Non-collision of references may, for example, be enforced by the e-receipt server using ordinal sequences or other appropriate methods as are known in the art.

In a further embodiment of the disclosure, the URL may be embedded in one or more mark-up elements using a mark-up language such as the extensible mark-up language (XML) or hypertext mark-up language (HTML). For example, the above URL may be embedded in a HTML link element as follows: <a href=“www.domain.com/2b01a2f0”>view receipt</a>

In yet a further embodiment of the disclosure, the reference may be embodied in a mark-up element using a mark-up language such that the reference can be extracted from the narrative and processed separately. For example:

<e-receipt>

<provider>www.domain.com</provider>
<reference>2b01a2f0</reference>

</e-receipt>

Thus, an identifier of the above form can be extracted and processed as required by a suitable function running on the issuing server. For example, the issuing server may be configured to remove any part of the narrative enclosed by a <e-receipt></e-receipt> element when generating a paper bank statement, but may generate suitable HTML to display the e-receipt details when generating an online statement.

Transaction messages sent according to the ISO 8583 standard are limited to a narrative of 100 alphanumeric characters or fewer. Thus embodiments of the invention wherein the transaction message is sent using the ISO 8583 standard must conform to the maximum narrative length. For example in some embodiments it may be desirable to use a URL alias in order to minimise the number of characters used to embed the reference. Such methods are well known in the art and are encompassed within the scope and spirit of the present invention.

It will be understood by those skilled the relevant art, that the format of the identifier is not limited to HTML, XML or any particular protocol and may be generated according to any of a wide range of protocols or according to combination of several protocols.

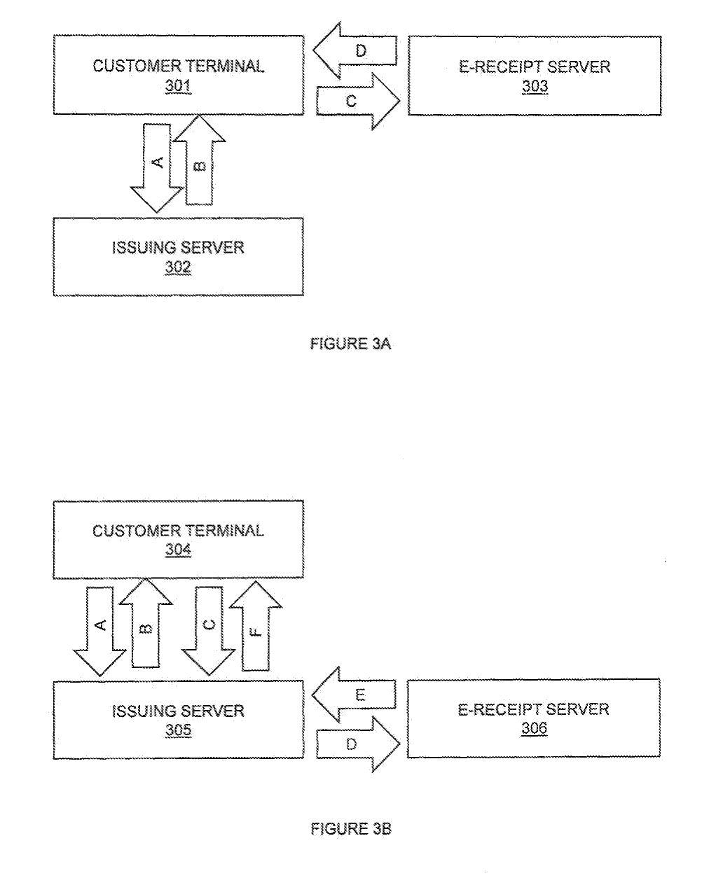

Subsequent to settlement of the transaction, the customer is able to access an online statement via a secure online banking website provided by the issuing server, as shown in FIG. 3A. In the illustrated embodiment, the customer accesses the online banking website hosted by the issuing server 302 using a web browser or suitable software running on the customer terminal 301. The customer directs their web browser to the online banking website and provides authentication data such as a user name and password in message A. The issuing server 302 responds by sending data B to produce a page showing a list of transactions with corresponding narrative including the identifiers previously generated by the e-receipt server 303. For example, for the above example where the identifier is embedded in an HTML link element, the corresponding transaction appearing in the electronic statement will include a clickable link, “view receipt”. If the customer chooses to click the link, the customer's web browser is directed to a web page hosted or generated by the e-receipt server 303. Upon receipt of the request C, the e-receipt server 303 retrieves the receipt data associated with the identifier, generates a web page presenting some or all of the retrieved data and returns the web page to the customer web browser which displays the e-receipt.

Alternatively, the online banking portal 305 may be configured to retrieve the e-receipt data directly from e-receipt server 306, as shown in FIG. 3B. In the illustrated embodiment, the e-receipt server 306 is configured to accept requests only from the issuing server 305 with which a pre-established security policy exists. Upon receiving the necessary authentication data A from the customer 304, the issuing server 305 generates data B which is returned to the customer terminal in order to provide a webpage showing a list of transactions with corresponding narrative. If the customer 304 subsequently requests to view the receipt for a particular transaction, a request C is sent to the issuing server 305, which then sends a request D to the e-receipt server 306 containing the e-receipt reference. Where the reference takes the form of a time stamp as discussed above, the issuing server 305 may be configured to retrieve the e-receipt data by providing the reference (timestamp) and the payment card number which together uniquely identify the associated e-receipt. As with the above example, the e-receipt server 306 retrieves the receipt data associated with the reference and returns the appropriate data to the issuing server 305 in message E. Finally, the issuing server 305 generates a web page presenting some or all of the retrieved data and returns the web page to the customer's web browser in message F which is displayed as an e-receipt. Thus, it is possible for the customer 304 to view an e-receipt without leaving the domain of the online banking website, which may be preferable from a security perspective.

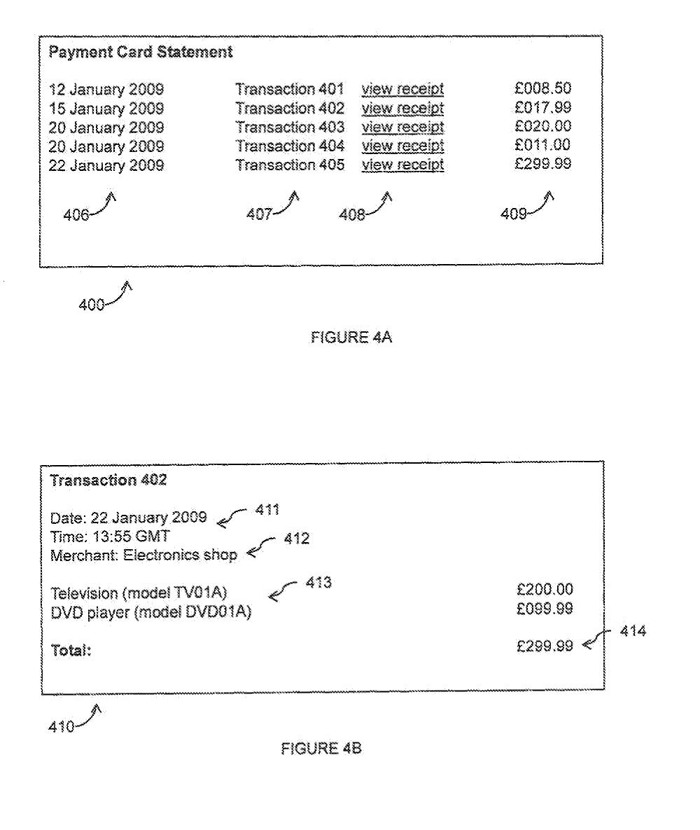

FIG. 4A shows an example online bank statement 400 in accordance with an embodiment of the present invention. The statement includes five transactions 401-405, each showing the transaction date 406, a brief narrative 407, a “view receipt” link 408 and the transaction amount 409. If the customer clicks on a “view receipt” link with his or her mouse, the customer's web browser displays the associated e-receipt in accordance with the methods discussed above. For example, if the customer clicks on the “view receipt” link associated with transaction 402, an e-receipt 410 of the form shown in FIG. 4B is displayed. The e-receipt shown in FIG. 4B includes the transaction date and time 411, merchant information 412, and a list of the items bought 413 with serial numbers, and the total transaction amount 414.

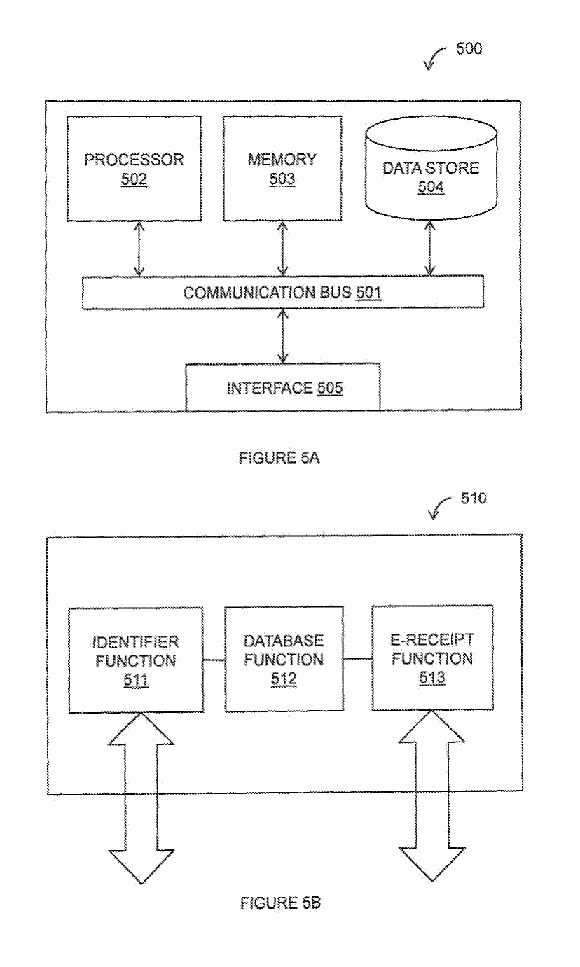

FIG. 5A shows an e-receipt server 500 in accordance with an embodiment of the present invention. The server comprises a communication bus 501, a processor 502, a memory 503, a data store 504 and an interface 505. The communication bus provides a means for transferring data between the processor 502, memory 503, data store 504 and interface 505. Memory 503 may be volatile memory such as RAM or non-volatile memory such as EPROM or flash memory. The data store 504 is a magnetic or optical storage medium arranged for storing data such as a database, a table, or a plurality of files. The processor 502 will typically be a software controlled microprocessor (for example an Intel Pentium™ processor) or an application specific integrated circuit (ASIC) or the like. The interface provides means for communicating with other entities in the payment system via a local or wide area network (for example the World Wide Web).

The processor 502 is configured to interact with the memory 503, data store 504 and interface 505 to perform a number of functions according to a software program. However, it will be appreciated that functionality may equally be realised using firmware, or an appropriate combination of both software and firmware. FIG. 5B illustrates the main functions 510 of the e-receipt server: an identifier function 511, a database function 512 and an e-receipt function 513.

The identifier function 511 controls interaction with a point of sale server. On receipt of the receipt data, the identifier function 511 generates the reference and identifier associated with the e-receipt and returns the identifier to the point of sale server. The database function 512 controls storage of the receipt data with the associated reference, and retrieval of the receipt data in response to a request from an entity such as an issuing bank.

The e-receipt function 513 is configured to generate one or more resources in response to receiving a receipt request from an entity. Typically, the request will be made according to the hypertext transfer protocol (HTTP) and may, for example, take the form: GET http://www.domain.com/2b01a2f0 HTTP/1.1 which corresponds to a request for the e-receipt with reference 2b01a2f0 using HTTP version 1.1. It will be appreciated by those of normal skill in the art that a request may be made using any of a number of protocols, and the HTTP is provided by way of example only. The received request will be passed to the database function 512 which locates and retrieves the appropriate receipt data from the data store. Next, the e-receipt function 513 generates the one or more resources associated with the e-receipt. A resource may comprise HTML code to produce a web-page containing the receipt data. Alternatively or additionally, the one or more resources may comprise an image of the receipt, for example, in bitmap in JPEG format. In a further exemplary embodiment, a digital signature may be embedded in the receipt image (either visible or invisible) in the form of a digital watermark so as to provide a degree of tamper protection for the resulting e-receipt. After the one or more resources have been generated by the e-receipt server, they are returned to the requesting entity using the HTTP protocol or other suitable protocol.

The e-receipt server can be further adapted to store each e-receipt in line with the relevant financial regulations or national and/or state laws. For example, where it may be required by law to store bank statements for a minimum period of time, it may be desirable to store the e-receipts for at least the same minimum time period.

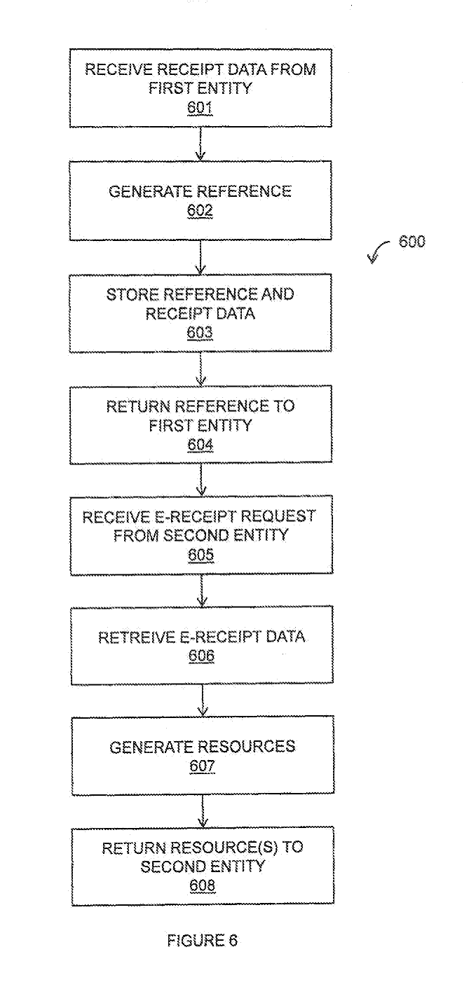

FIG. 6 is a flow diagram 600 illustrating an exemplary method for producing an e-receipt in accordance with an exemplary embodiment of the e-receipt server. First, the e-receipt server receives receipt data from a first entity [step 601] which is typically the merchant's point of sale system. The e-receipt server generates a reference associated with the e-receipt based on the payment card number and other additional data [step 602]. Next, the e-receipt server stores the e-receipt data with the reference [step 603] and returns the reference to the first entity [step 604]. Upon receipt of an e-receipt request from a second entity [step 605], the e-receipt server retrieves the e-receipt data [step 606], generates one or more resources [step 607] and returns the resources to the second entity [608].

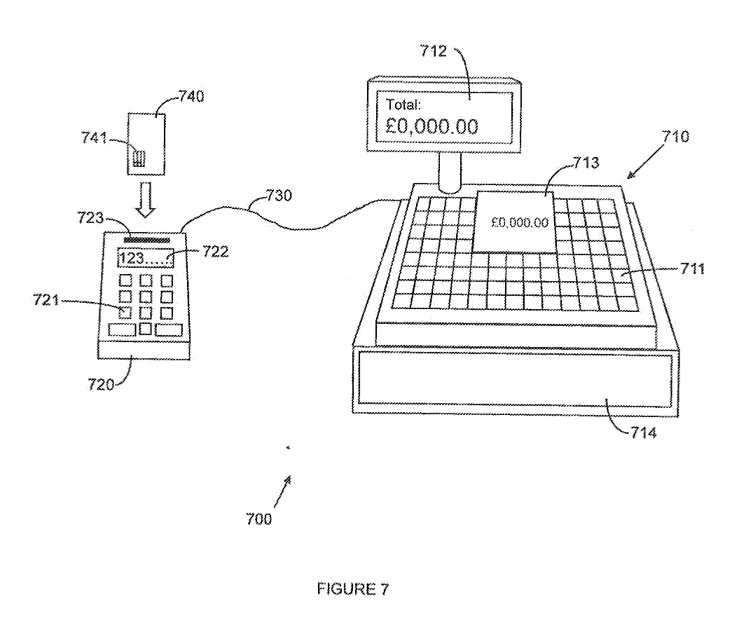

FIG. 7 shows an EPoS system 700 in accordance with an exemplary embodiment of the present disclosure. Specifically, FIG. 7 illustrates an EPoS terminal 710 and a chip and PIN card reader 720. The chip and PIN card reader 720 is connected to the EPoS terminal 710 via a standard interface cable 730 (although in other embodiments the EPoS terminal 710 and the card reader 720 could be connected wirelessly using a suitable wireless protocol). The EPoS terminal 710 typically comprises a keyboard 711, a pole display 712, an operator display 713, and a cash drawer 714. The chip and PIN reader 720 typically comprises a keypad 721, which is used by a customer for entering the PIN for his or her payment card, a display 722 for providing prompts and progress feedback to the customer, and a slot 723 for receiving a chip and PIN payment card 740. The chip and PIN card 740 comprises a chip with associated contact pads 741. Typically, the dimensions of the chip and PIN card 740 and location of the contact pads 741 will conform to the ISO 7810 standard and associated extension standards such as ISO 7816. However, it will be appreciated the illustrated apparatus can be modified to accommodate any changes in card standards or any replacement standards which may be developed in the future. All such modifications are within the scope and spirit of the present invention. Additionally or alternatively, the chip and PIN card may be adapted to communicate with the chip and PIN reader using a wireless technology such as RFID (e.g. Visa PayWave™ or Mastercard PayPass™), and such arrangements are also intended to fall within the scope and spirit of the present invention.

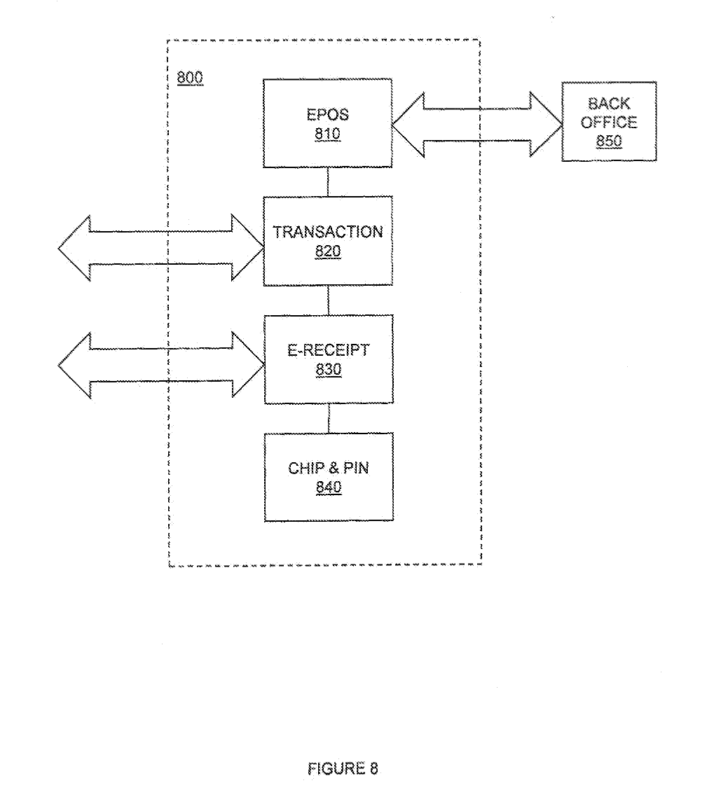

FIG. 8 shows the functional elements of an EPoS system according to an exemplary embodiment of the present disclosure. The illustrated EPoS system is for use with chip and PIN type payment cards, where the payment card includes an embedded microchip which securely stores the customer's PIN. When the customer wishes to pay for goods or services using the chip and PIN system, he or she must enter his or her PIN into a card reader which reads the securely stored pin and verifies that the correct PIN has been inputted. The chip and PIN standard is based on the EMV (Europay™, MasterCard™ and VISA™) standard for secure payments which is hereby incorporated by reference.

For the present purposes, the EPoS system 800 comprises three main functional blocks: an EPoS function 810, a transaction function 820, an e-receipt function 830 and a chip and PIN card reader function 840. Generally-speaking, these functions control the EPoS terminal 710 and chip and PIN card reader 720, and are realised in software, firmware, hardware, or an appropriate combination thereof. In the context of FIG. 8, the transaction function 820 manages all communications (i) between the EPoS terminal 710 and the chip and PIN card reader 720 and (ii) between the chip and PIN card reader 720 and the transaction servers which may include the acquiring server and/or the issuing server. The EPoS function 810 manages the EPoS terminal 710 and the chip and PIN card reader function 840 manages the keypad 721 and the interactions between a chip and PIN card 740 and the chip and PIN card reader 720. The e-receipt function 830 manages the sending of receipt data to the e-receipt server, and may also interact with the transaction function 820 and the chip and PIN function in order to generate receipt data and embed e-receipt identifiers in transaction messages.

The functional components that are shown in the EPoS system 800 of FIG. 8 may be distributed in various different ways depending on the exact nature of the hardware, in the system 700, which may vary from that illustrated in FIG. 7. For example, the chip and PIN functionality 840 may reside mainly on a standalone chip and PIN card reader 720 and the EPoS functionality may reside mainly on an EPoS terminal 710. The transaction functionality 820 may then reside either mainly on the chip and PIN card reader 720 or mainly on the EPoS terminal 710. Alternatively, the chip and PIN card reader 720 may provide a physical enclosure containing an interface for chip and PIN payment cards 740 and a keypad 721 only, while the bulk of the respective chip and PIN functionality 840 may reside on the EPoS terminal 710. In such a case, the transaction functionality 820 may also reside mainly on the EPoS terminal 710. As another possible alternative, the EPoS terminal 710 and the chip and PIN card reader 720 may comprise an integrated unit and then all functionality may reside on that unit. As a further possible alternative, the chip and PIN card reader functionality 840 may reside on an independent system, separate from both the EPoS terminal and the chip and PIN card reader. Hence, unless otherwise indicated, embodiments of the EPoS system are described hereafter without reference to physical location of the functionality in question.

In large retail environments, it is commonplace for a plurality of EPoS systems to be connected to a back office server 850, which consolidates the transactions of all the EPoS terminals and performs various stock keeping operations. In such a system, which is sometimes referred to as an integrated point of sale (iPoS) system, at least some of the EPoS functionality may also reside on the back office server 850. It will be appreciated that, while the diagram in FIG. 8 shows only one EPoS system 800, in practice there are likely to be many, for example tens, hundreds or even thousands of similar systems attached to a single back end server.

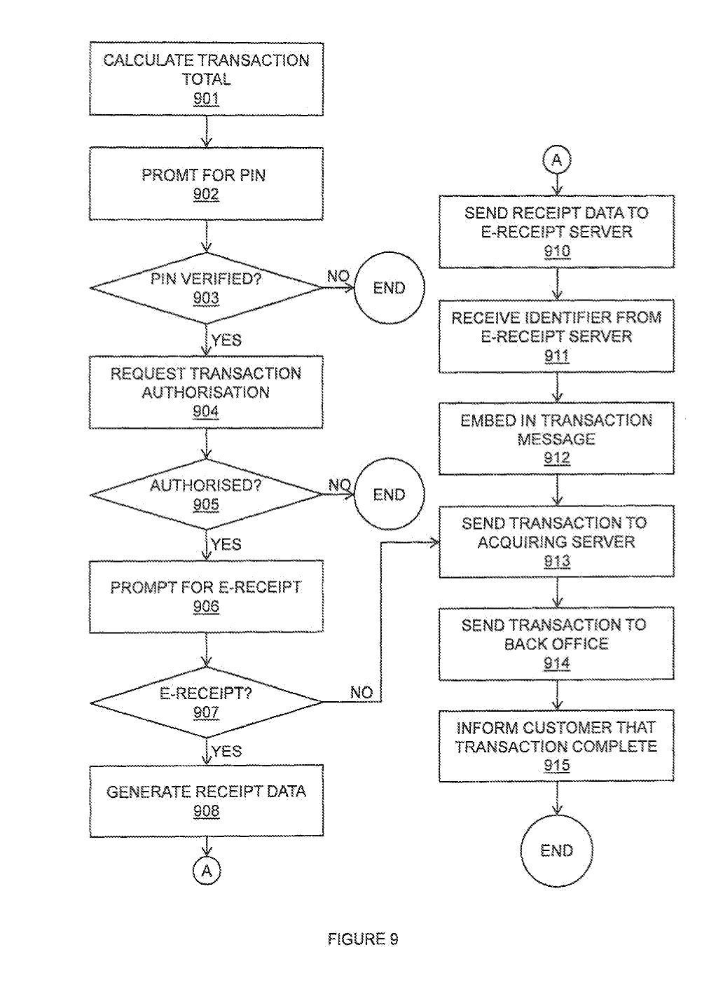

FIG. 9 is a flow chart showing the principle steps involved in generating an e-receipt, in accordance with an exemplary embodiment of the EPoS system shown in FIGS. 7 and 8. First, the EPoS function 810 calculates the total monetary amount for a transaction [step 901]. Next, the chip and PIN function prompts for the customer's PIN using the display 722 [step 902]. The customer inputs his or her PIN using the keypad 721 and the chip and PIN function 840 verifies that the input PIN matches the PIN stored on the customer's payment card [step 903]. Typically, PIN verification is implemented using the methods as specified in the EMV card standard but may be implemented according to other standards with may vary geographically. Next, the transaction function sends the transaction details for approval from the issuing server [step 904] and if a message is returned authorising the transaction [step 905], the chip and PIN function 840 prompts the customer [step 906] to select whether he or she would like an e-receipt [step 907]. If the customer selects the option to generate an e-receipt (generally done by pressing the “OK” button on keypad 721), the e-receipt function 830 generates the receipt data based on the goods or services associated with the transaction [step 908], then sends the receipt data to the e-receipt server [step 910]. Next, the e-receipt identifier is received from the e-receipt server [step 911] and is embedded into the narrative of the approved transaction message [step 912]. Next, the approved transaction message is sent to the acquiring server [step 913] and in some embodiments may be sent to the back office [step 914]. Finally, the customer is informed that the transaction process is complete via a message on display 722 [step 915].

In the case where no e-receipt is requested by the customer [step 907], the EPoS system does not generate or send receipt data to the e-receipt server, and instead proceeds to send the transaction data to the acquiring server [step 913] in the normal way, send transaction data to the back office server [step 914] and inform the customer that the transaction is complete [915]. Where no e-receipt is generated, it may be desirable to print a paper receipt as in prior art methods. In other cases it may be desirable to generate an e-receipt and a conventional paper receipt.

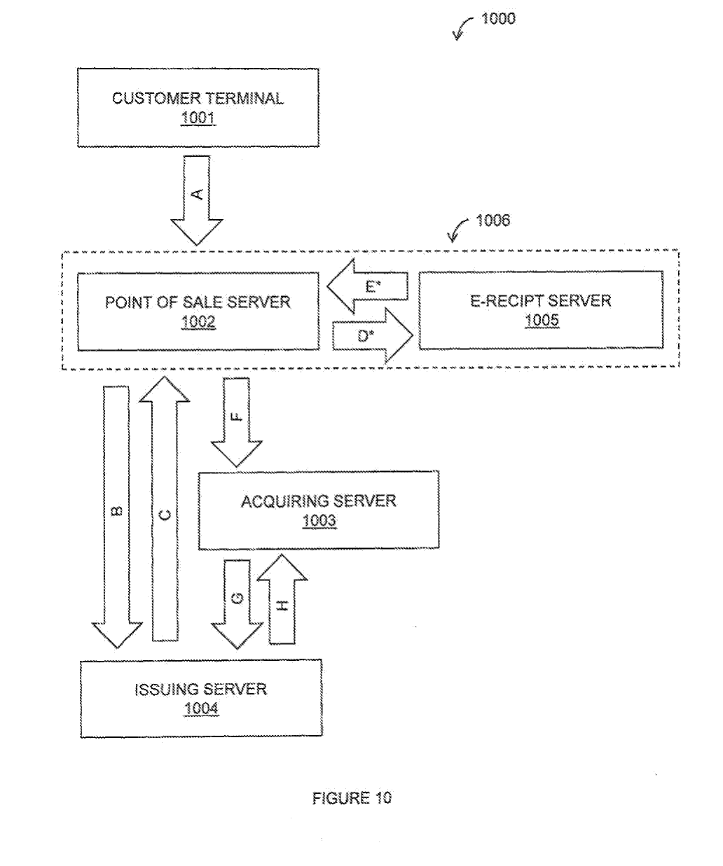

It will be apparent to a person of normal skill in the art that the present disclosure may be combined with various security and authentication technologies to ensure non-repudiation of the e-receipt. FIG. 10 shows an exemplary embodiment of the present disclosure similar to that shown in FIG. 2 comprising a customer terminal 1001, a point of sale server 1002, an acquiring server 1003, an issuing server 1004 and an e-receipt server 1005. The embodiment shown in FIG. 10 also comprises a private key infrastructure (PKI) 1006 between the point of sale server 1002 and the e-receipt server 1005. The messages A-C and F-H are substantially the same as those shown in FIG. 2 with the same letter. However, messages E* & D* differ as will now be described. The PKI 1006 may be implemented in hardware or software using standard techniques as are known in the art. In the illustrated embodiment, the point of sale server 1002 sends to the e-receipt server 1005 a signed message D* containing the details of the goods and/or services and details of the payment card used by the customer. Message D* is signed using the private key of the point of sale server 1002 thereby providing a guarantee that the message originated from the point of sale server 1002 (hence message D* is non-repudiable). Similarly, message E* containing the e-receipt reference is signed by the e-receipt server 1005 and returned to the point of sale server 1002, thereby guaranteeing the e-receipt cannot be repudiated. In a further embodiment, the point of sale server 1002, point of sale terminal 710 or chip and PIN card reader 720 may additionally comprise a display to display the receipt generated by the e-receipt server 1005 such that a customer may view the receipt in order to ensure that the e-receipt is accurate and trust-worthy. Thus, the customer will be able to identify if erroneous information was accidentally sent by the merchant, or the wrong e-receipt was accidentally generated and stored by the e-receipt server. Additionally or alternatively, the point of sale terminal 710 and PIN card reader 720 may be adapted such that customer is able to sign the e-receipt using a smart card function in the payment card or by manually providing a signature using a digital tablet to convert the signature to a digital format. Then the customer's signature in digital format may be sent to the e-receipt server with the receipt data at step 908. In this way the e-receipt also becomes non-repudiable from a customer perspective.

In some embodiments of the present disclosure, there may be several e-receipt providers. For example, each issuing bank or card provider may operate a separate e-receipt server. In such cases, the EPoS system is configured to determine to which e-receipt server to send receipt data to on the basis of data stored on the payment card. For example, if the payment card is associated with issuing bank A, the e-receipt server is configured to contact the e-receipt server associated with that bank. Such functionality may, for example, be incorporated in e-receipt function 830 or the chip and PIN function 840.

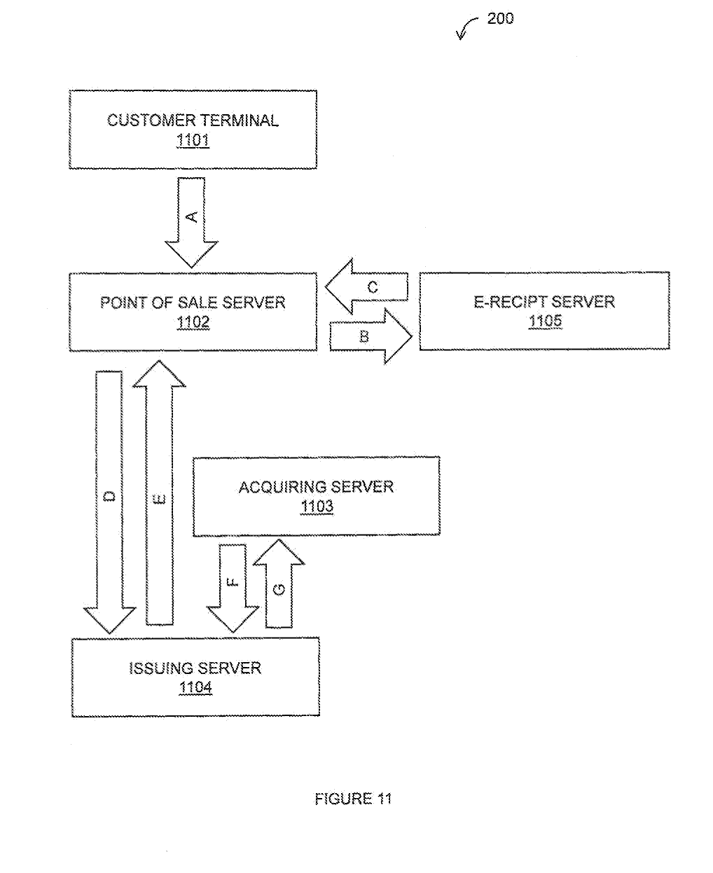

It is envisaged that in some embodiments of the disclosure the e-receipt will be generated prior to obtaining authorisation for the transaction, as shown in FIG. 11. In the embodiment shown in FIG. 11, the customer first initiates an electronic transaction with a merchant at the point of sale server 1102, either by purchasing goods and services via an e-commerce website, or in person using an EPoS system (for example in a retail store). In both instances, the customer will provide payment card details such as payment card number and expiry date (and optionally relevant cardholder data such as name or date of birth) which are sent to the point of sale server 1102 along with details of the goods and/or services purchased in message A. As with the previously described embodiment, the goods involved in the transaction may be identified by an identification code such as an SKU number.

As with the previous embodiments, before sending details of the goods and services to the e-receipt server 1105, the point of sale server may optionally present the customer with an option to generate an e-receipt. For example, in the case of an EPoS system, the customer may be prompted to press “OK” on a card reader keypad if they want an e-receipt, or “CANCEL” if they do not require a receipt. Thus, the customer has the option to prevent a receipt from being generated for goods and services of a trivial or private nature. In a further embodiment, if the customer does not require or want an e-receipt to be generated (i.e. the customer presses “CANCEL” on the keypad), a conventional paper receipt may be printed by a conventional receipt printer operably attached to the EPoS system. In yet another embodiment, the contents of the e-receipt may be presented to the customer on a screen for validation prior to sending to the e-receipt server 1105.

Upon receipt of message A, and if an e-receipt has been requested, the point of sale server 1102 sends a message B to the e-receipt server 1105 containing the details of the goods and/or services and the details of the payment card used by the customer. The e-receipt server 1105 generates a unique alphanumeric reference for the transaction based on some or all of the payment card details (and optionally relevant cardholder data such as name or date of birth) and stores the details of goods/services with the reference. Next, a transaction identifier which includes the reference is returned to the point of sale server 1102 in message C.

Next, the point of sale server 1102 generates and transmits a message D containing details of the transaction to the issuing server of the customer 1104 using a suitable protocol (for example the ISO 8583 standard for financial transaction card originating messages, hereby incorporated by reference). The transaction message will typically comprise information derived from the payment card used (for example the account number, expiry date), the point of sale used to make the transaction (for example the merchant number), the transaction amount and currency. Message D will also comprise a transaction narrative provided by the merchant. Typically the narrative will include text containing the merchant name and short address and will appear on the customer's paper or electronic bank statement with the corresponding transaction. The identifier generated by the e-receipt server 1105 and associated with the transaction is appended to or embedded in the narrative field in message D. Thus the narrative associated with the transaction provides a link to the record of the associated goods and services stored on the e-receipt server.

Upon receipt of the message D from the point of sale server 1102, the issuing server 1104 of the customer may perform one or more checks to confirm the transaction is genuine (i.e. not fraudulent) and that the customer has sufficient funds or credit in place to purchase the goods or services. If the message is genuine and the customer has sufficient funds or credit to complete the transaction, the issuing server 1104 returns a message E approving the transaction. Again, typically message E will be returned to the point of sale server 1102 via the acquiring server of the merchant 1103 (not shown in FIG. 11).

It will be appreciated that in this embodiment, an e-receipt associated with a particular transaction is generated prior to obtaining authorisation for the transaction in question. Thus should the transaction be declined by the issuing server 1104, data pertaining to the transaction remains on the e-receipt server unless further action is taken. In some embodiments, the point of sale server 1102 may be configured, upon notification of a declined transaction, to send a request to the e-receipt server to delete the relevant receipt data. Alternatively, if it is deemed acceptable, the receipt data relating to the declined receipt may be left on the e-receipt server 1105.

Settlement of the transaction between the acquiring bank and the issuing bank (i.e. the transfer of funds) may be performed in real time, in batches or according to a daily schedule. Although settlement may be achieved via direct communication between the acquiring server 1103 and the issuing server 1104 (messages F and G), it is more common to use a bank card association such as MasterCard™ or Visa™. Following settlement, the acquiring server 1103 and issuing server 1104 update the merchant and customer accounts respectively in accordance with the transaction.

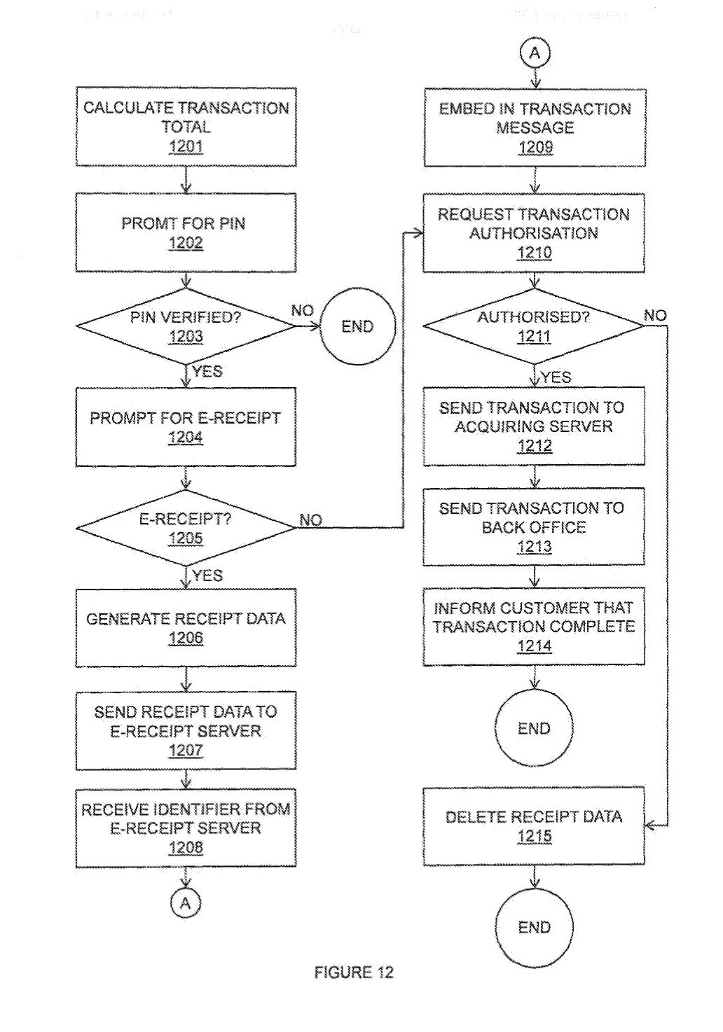

FIG. 12 is a flow chart showing the principle steps involved in generating an e-receipt, in accordance with the embodiment shown in FIG. 11. First, the EPoS function 810 calculates the total monetary amount for a transaction [step 1201]. Next, the chip and PIN function prompts for the customer's PIN using the display 722 [step 1202]. The customer inputs his or her PIN using the keypad 721 and the chip and PIN function 840 verifies that the input PIN matches the PIN stored on the customer's payment card [step 1203]. Typically, PIN verification is implemented using the methods as specified in the EMV card standard but may be implemented according to other standards with may vary geographically. Next, the chip and PIN function 840 prompts the customer to select whether he or she would like an e-receipt [step 1205]. If the customer selects the option to generate an e-receipt (generally done by pressing the “OK” button on keypad 721), the e-receipt function 830 generates the receipt data based on the goods or services associated with the transaction [step 1206], then sends the receipt data to the e-receipt server [step 1207]. Next, the e-receipt identifier is received from the e-receipt server [step 1208] and is embedded into the narrative of the transaction message [step 1209]. Next, the transaction function sends the transaction details with embedded e-receipt identifier for approval from the issuing server [step 1210]. If a message is returned authorising the transaction, the approved transaction message is sent to the acquiring server [step 1212] and in some embodiments may be sent to the back office [step 1213] and the customer is informed that the transaction process is complete via a message on display 722 [step 1215]. Where a transaction is declined by the issuing server, the e-receipt function 830 may optionally request that the e-receipt server delete the relevant receipt data [step 1215].

In the case where no e-receipt is requested by the customer [step 1205], the EPoS system does not generate or send receipt data to the e-receipt server, and instead proceeds to send the transaction data to the acquiring server [step 1210] in the normal way, send transaction data to the back office server [step 1213] and inform the customer that the transaction is complete [1214]. Where no e-receipt is generated, it may be desirable to print a paper receipt as is prior art methods. In other cases it may be desirable to generate an e-receipt and a conventional paper receipt.

The embodiments described hereinbefore have been associated with an electronic point of sales system as shown in FIGS. 7 and 8. However, the methods and apparatus described may equally be performed using an e-commerce point of sale which a customer may access using a personal computer, mobile telephone, personal digital assistant or any other suitable Internet enabled device. In such circumstances, the customer will direct an Internet browser to a portal provided by the e-commerce point of sale server whereby goods and/or services can be purchased.

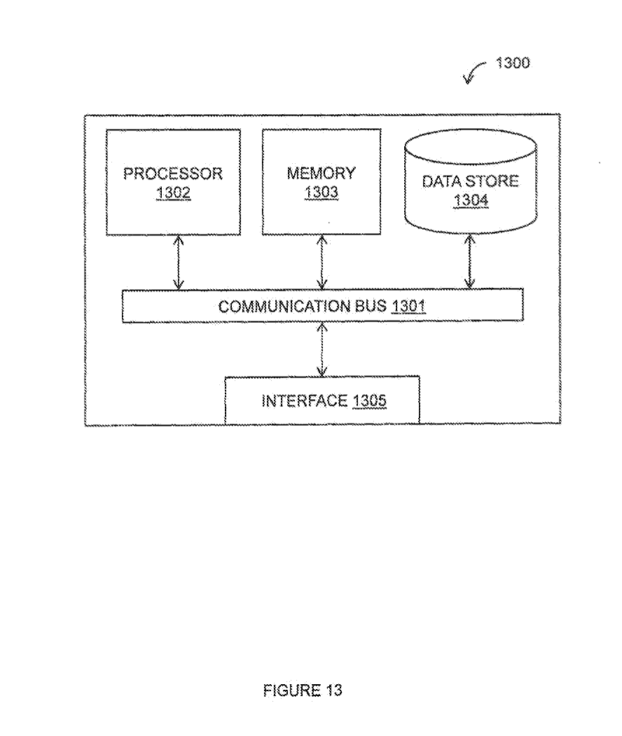

FIG. 13 shows an exemplary e-commerce point of sale server 1300 in accordance with an exemplary embodiment of the present disclosure. The server comprises a communication bus 1301, a processor 1302, a memory 1303, a data store 1304 and an interface 1305. The communication bus provides a means for transferring data between the processor 1302, memory 1303, data store 1304 and interface 1305. Memory 1303 may be volatile memory such as RAM or non-volatile memory such as EPROM or flash memory. The data store 1304 is a magnetic or optical storage medium arranged for storing data such as a database, a table, or a plurality of files. The processor 1302 will typically be a software controlled microprocessor (for example an Intel Pentium™ processor) or an application specific integrated circuit (ASIC) or the like. The interface provides means for communicating with other entities in the payment system via a local or wide area network (for example the World Wide Web). The processor 1302 is configured to interact with the memory 1303, data store 1304 and interface 1305 to perform a number of functions according to a software program. However, it will be appreciated that the functionality may equally be realised using firmware, hardware, or an appropriate combination of the three.

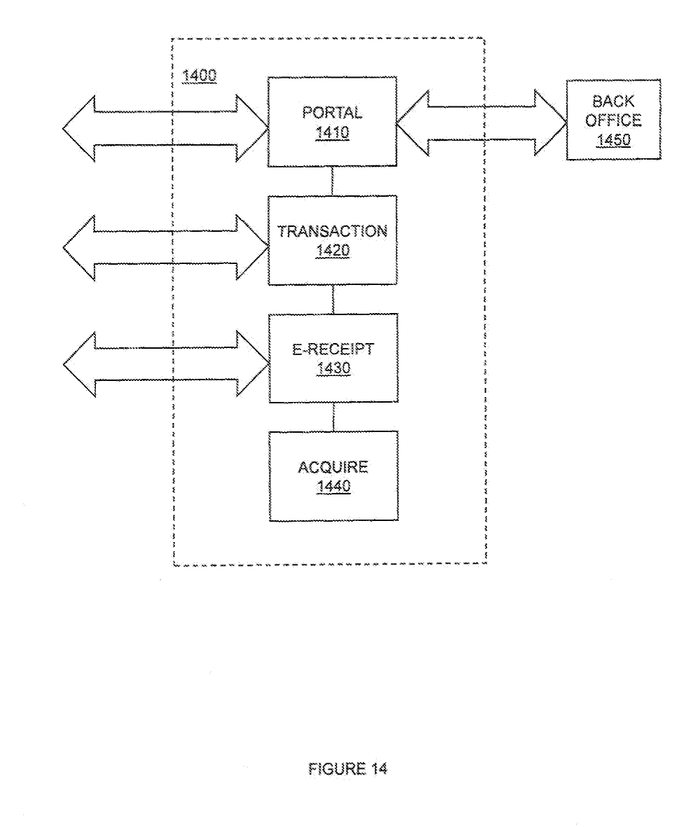

FIG. 14 shows the functional operation of the e-commerce point of sale system 1400 in accordance with an exemplary embodiment of the present disclosure. The system 1400 comprises a portal function 1410, a transaction function 1420, an e-receipt function 1430 and an acquire function 1440. In some embodiments it is envisaged that the system 1400 will be operable with a back office function 1450. The transaction function 1420 manages all communications with the transaction servers which may include the acquiring server and/or the issuing server. The portal function 1410 manages the e-commerce portal presented to the customer and the acquire function 1440 manages the secure acquisition of the customer's payment card details and optionally any relevant cardholder data such as name or date of birth. The e-receipt function 1430 manages the sending of receipt data to the e-receipt server, and may also interact with the transaction function 1420 and the acquire function 1440 in order to generate receipt data and embed e-receipt identifiers in transaction messages.

The e-commerce server shown in FIGS. 13 and 14 can be used with any of the previously described methods, including but not limited to, the methods of FIGS. 9 and 12. It will be appreciated by those of normal skill in the art that where a method step requires use of a payment card chip and PIN function, this may be replaced by any suitable authentication measure as is common place in the field of e-commerce. Furthermore, it will be appreciated by those skilled in the art that embodiments the e-receipt server as described hereinbefore are substantially independent of the point of sale apparatus used and this provides an advantageously flexible solution for providing electronic receipts. For example, the e-receipt server may operate with a plurality of different point of sale servers, each operated by a different merchant.

The above embodiments are to be understood as illustrative examples of the disclosure. Further embodiments of the disclosure are envisaged. For example, the e-receipt server may be adapted to digitally sign an e-receipt so as to guarantee authenticity with regard insurance claims or similar. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An electronic receipt server comprising:
an interface;
a data store; and
a processor adapted:
on receiving receipt data associated with a customer purchase transaction from a first entity, to generate a reference associated with the customer purchase transaction, store the receipt data in the data store in association with the reference and return the reference to the first entity;
on receipt of a request comprising the reference from a second entity, to send an electronic receipt to the second entity, the electronic receipt being associated with the reference and presenting the customer purchase transaction according to the receipt data.

2. An electronic receipt server according to claim 1, wherein the electronic receipt comprises an image.

3. An electronic receipt server according to claim 1, wherein the processor is further configured to digitally sign the reference.

4. An electronic receipt server according to claim 1, wherein the processor is further configured to digitally sign the electronic receipt.

5. An electronic receipt server according to claim 1, wherein the receipt data comprises a payment card number and/or cardholder data associated with the customer purchase transaction, and the reference is generated on the basis of the payment card number.

6. An electronic point of sale system comprising:
a card reader adapted to read card details from a payment card; and
a terminal adapted to:
send receipt data associated with a customer purchase transaction to a first entity;
receive a reference associated with an electronic receipt corresponding to the customer purchase transaction from the first entity;
embed the reference in a message associated with the customer purchase transaction; and
send the message to a second entity.

7. An electronic point of sale system according to claim 6, wherein the terminal is further adapted determine the identity of the first entity on the basis of an address stored in the payment card.

8. An electronic point of sale system according to claim 6, wherein the terminal is further adapted to digitally sign the receipt data sent to the first entity.

9. An electronic point of sale system according to claim 6, wherein the first entity is an electronic receipt server comprising:
an interface;
a data store; and
a processor adapted:
on receiving receipt data associated with a customer purchase transaction from a first entity, to generate a reference associated with the customer purchase transaction, store the receipt data in the data store in association with the reference and return the reference to the first entity;
on receipt of a request comprising the reference from a second entity, to send an electronic receipt to the second entity, the electronic receipt being associated with the reference and presenting the customer purchase transaction according to the receipt data

10. A method of generating an electronic receipt comprising:
receiving receipt data associated with a customer purchase transaction from a first entity;
generating a reference associated with the customer purchase transaction;
storing the receipt data in the data store in association with the reference; and
returning the reference to the first entity.

11. A method according to claim 10 further comprising:
receiving a request comprising the reference from a second entity; and
sending an electronic receipt to the second entity, the electronic receipt being associated with the reference and presenting the customer purchase transaction according to the receipt data.

12. A method according to claim 11, wherein generating the electronic receipt comprises generating an image.

13. A method according to claim 10, wherein the method further comprises digitally signing the electronic receipt.

14. A method according to claim 10, wherein the receipt data comprises a payment card number and the reference is generated of the on the basis of the payment card number.

15. A method of processing a customer purchase transaction comprising:
reading card details from a payment card;
sending receipt data associated with a customer purchase transaction to a first entity;
receiving a reference associated with an electronic receipt corresponding to the customer purchase transaction from the first entity;
embedding the reference in a message associated with the customer purchase transaction; and
sending the message to a second entity.

16. A method according to claim 15, wherein the method further comprises determining the identity of the first entity on the basis of an address stored in the payment card.

17. A method according to claim 15, wherein the method further comprises digitally signing the receipt data sent to the first entity.

18. A method according to claim 15, wherein the first entity is an electronic receipt server comprising:
an interface;
a data store; and
a processor adapted:
on receiving receipt data associated with a customer purchase transaction from a first entity, to generate a reference associated with the customer purchase transaction, store the receipt data in the data store in association with the reference and return the reference to the first entity;
on receipt of a request comprising the reference from a second entity, to send an electronic receipt to the second entity, the electronic receipt being associated with the reference and presenting the customer purchase transaction according to the receipt data.

19. A payment card comprising a processor chip storing the address of an electronic receipt server in accordance with claim 1.

20. An e-commerce point of sale server adapted to:
receive card details from a payment card;
send receipt data associated with a customer purchase transaction to a first entity;
receive a reference associated with an electronic receipt corresponding to the customer purchase transaction from the first entity;
embed the reference in a message associated with the customer purchase transaction; and
send the message to a second entity.
